(19) United States
(12) Patent Application Publication
(10) Pub. No.: US 2022/0238981 A1
(43) Pub. Date: Jul. 28, 2022

(54) POLE MOUNTING BRACKET

(71) Applicant: CommScope Technologies LLC, Hickory, NC (US)

(72) Inventors: Scott O. CHARLES, Hickory, NC (US); Hector Luis GARCIA, Juarez (MX); Jesus Gustavo PURECO CHICO, Juarez (MX); Robert BACHTELL, Minneapolis, MN (US); Emmanuel Alberto ALTAMIRANO ESCOBEDO, Juarez (MX)

(21) Appl. No.: 17/581,109

(22) Filed: Jan. 21, 2022

Related U.S. Application Data
(60) Provisional application No. 63/140,555, filed on Jan. 22, 2021.

(51) Int. Cl. H01Q 1/12; F16M 13/02; F16M 11/00

(52) U.S. Cl. CPC H01Q 1/1228; F16M 2200/065; F16M 11/00; F16M 13/02

(57) ABSTRACT

The present disclosure relates generally to universal pole mounting brackets for mounting telecommunications enclosures used in fiber optic distribution systems. The pole mounting brackets are adapted to mount telecommunications enclosures to a structure, such as, a post. A pole mounting bracket can include a central support section that includes a first end and an opposite, second end. The central support section can be elongated along a longitudinal axis between the first end and the second end. The pole mounting bracket can also include a first lateral support member transversely aligned relative to the central support section and a second lateral support member transversely aligned relative to the central support section. The first and second lateral support members can each define a plurality of apertures for receiving mounting structures adapted to operatively connect at least two different types of enclosures to the first and second lateral support members.

### TECHNICAL FIELD

The present disclosure relates generally to devices for mounting enclosures. More particularly, the present disclosure relates to pole mounting brackets for mounting telecommunications enclosures used in fiber optic distribution systems.

### BACKGROUND

Numerous telecommunications enclosures exist today and are used in various applications. One such application is for use in fiber distribution to multiple dwelling units (MDU's). In many applications, telecommunications enclosures are configured to house various telecommunications components (e.g., adapters, splitter, cables, etc.) in a single main compartment. The telecommunications enclosures can be configured as boxes or housings that encloses various telecommunications components in an indoor or outdoor environment and that provide optical; connection points for connecting subscribers to a fiber optic network.

Certain telecommunications enclosures can be utilized as a final distribution point in a “Fiber to the X (FTTX)” network, for example in a network where individual fibers from the telecommunications enclosure are routed to individual living spaces in a multiple dwelling unit (MDU) or other subscriber locations. Telecommunications enclosures can have various sizes of widths and may be mounted to a surface, such as a wall or pole, by mechanical fasteners, such as screws. Enclosures can be mounted to a pole or wall through the use of an intermediate bracket. U.S. Pat. Nos. 7,477,824; 7,558,458; 7,627,222; and PCT International Publication No. WO2019/209645 disclose example enclosure mounting brackets.

### SUMMARY

The present disclosure relates generally to universal pole mounting brackets for mounting telecommunications enclosures used in fiber optic distribution systems. The pole mounting brackets are adapted to mount telecommunications enclosures to a structure, such as, a pole. In one example, a bracket is “universal” to the extent it is configured to be compatible with multiple types and/or sizes of different enclosures.

One aspect of the present disclosure relates to a pole mounting bracket. The pole mounting bracket can include a central support section that includes a first end and an opposite, second end. The central support section can be elongated along a longitudinal axis between the first end and the second end. The central support section defines a plurality of fastener openings along the longitudinal axis. The pole mounting bracket also includes a first lateral support member transversely aligned relative to the central support section and a second lateral support member transversely aligned relative to the central support section. The second lateral support member can be parallel to the first lateral support member. The first and second lateral support members can be stepped forwardly from the central support section to be positioned offset relative to the central support section. The first and second lateral support members can each define a plurality of apertures for receiving mounting structures adapted to operatively connect at least two different types of enclosures to the first and second lateral support members. In one example, the bracket defines at least first and second different aperture lay-outs or patterns respectively compatible with first and second different enclosure types and/or sizes.

Another aspect of the present disclosure relates to pole mounting bracket that includes a central support section having a first end and an opposite, second end. The central support section can be elongated along a longitudinal axis between the first end and the second end. The pole mounting bracket includes a upper section aligned parallel to the central support section and a lower section aligned parallel to the central support section and the upper section. A lateral support member can be transversely aligned relative to the central support section. The lateral support member can include a left portion that projects laterally out from the central support section and a right portion that projects laterally out from the central support section. The upper and lower sections can be stepped rearwardly from the central support section to be positioned offset relative to the central support section. The left and right portions of the lateral support member each defines an aperture for receiving a mounting structure adapted to operatively connect an enclosure to the lateral support member.

Another aspect of the present disclosure relates to a pole mounting bracket. The pole mounting bracket can include a central support section that includes a first end and an opposite, second end. The central support section can be elongated along a longitudinal axis between the first end and the second end. The central support section defines a plurality of fastener openings along the longitudinal axis. The central support section can include a first set of tab arms that extend from opposite sides of the central support section adjacent the first end and a second set of tab arms that extend from opposite sides of the central support section adjacent the second end. The pole mounting bracket can also include a first lateral support member transversely aligned relative to the central support section and a second lateral support member transversely aligned relative to the central support section. The second lateral support member can be parallel to the first lateral support member. The first and second lateral support members can be stepped forwardly from the central support section to be positioned offset relative to the central support section. The stepped portions between the central support section and the first and second lateral support members can each define a slot. The first and second lateral support members are adapted to operatively connect at least two different types of enclosures to the first and second lateral support members.

A further aspect of the present disclosure relates to a pole mounting bracket that mounts both a wall box and a plastic skirt together. The pole mounting bracket can include a central support section with a first end and an opposite, second end. The central support section can be elongated along a longitudinal axis between the first end and the second end. The central support section defines a plurality of fastener openings along the longitudinal axis. A first lateral support member can be transversely aligned relative to the central support section; a second lateral support member can be transversely aligned relative to the central support section; a third lateral support member can be transversely aligned relative to the central support section; and a fourth lateral support member can transversely align relative to the central support section. The first, second, third, and fourth lateral support members can be parallel to one another. The first, second, third, and fourth lateral support members can be stepped forwardly from the central support section to be positioned offset relative to the central support section. The first and second lateral support members can each define a plurality of apertures for receiving mounting structures adapted to operatively connect at least two different types of enclosures to the first and second lateral support members. The third and fourth lateral support members can each define a plurality of apertures for receiving mounting structures adapted to operatively connect an enclosure skirt to the third and fourth lateral support members.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 illustrates a rear perspective view of an pole mounting bracket in accordance with principles of the present disclosure.

FIG. 2 illustrates a front perspective view of the pole mounting bracket of FIG. 1.

FIG. 3 illustrates a plan view of the pole mounting bracket of FIG. 1.

FIG. 4 illustrates a top view of the pole mounting bracket of FIG. 1.

FIG. 5 illustrates a side view of the pole mounting bracket of FIG. 1.

FIG. 6 illustrates a top view of the pole mounting bracket with a first enclosure type mounted to a post via the pole mounting bracket in accordance with the principles of the present disclosure.

FIG. 7 illustrates a side view of the pole mounting bracket mounted to the post including an enclosure skirt below the first enclosure type.

FIG. 8 illustrates a perspective view showing the first enclosure type mounted to the pole mounting bracket of FIG. 1.

FIG. 9 illustrates a perspective view of a second enclosure type shown mounted to the pole mounting bracket of FIG. 1.

FIG. 10 illustrates a perspective view of the enclosure skirt of FIG. 7 shown mounted to the pole mounting bracket of FIG. 1.

FIG. 11 illustrates a perspective view showing two pole mounting brackets aligned end-to-end in accordance with the principles of the present disclosure.

FIG. 12 illustrates a perspective of an alternative pole mounting bracket in accordance with the principles of the present disclosure.

FIG. 13 illustrates a rear view of an enclosure mounted to the pole mounting bracket of FIG. 12.

FIG. 14 illustrates a perspective view of an alternative pole mounting bracket in accordance with the principles of the present disclosure.

FIG. 15 illustrates a plan view of the pole mounting bracket of FIG. 14.

FIG. 16 illustrates a perspective view of the pole mounting bracket of FIG. 14 mounted to the post including the enclosure skirt below the first enclosure type.

FIG. 17 illustrates a front view of the enclosure skirt and the first enclosure type of FIG. 16 mounted to the post.

FIG. 18 illustrates a front view of the enclosure skirt mounted to the pole mounting bracket without the first enclosure type.

FIG. 19 illustrates a back plate and organizer for the enclosure skirt in accordance with the principles of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention. Additionally, any examples set forth in this specification are not intended to be limiting and merely set forth some of the many possible embodiments.

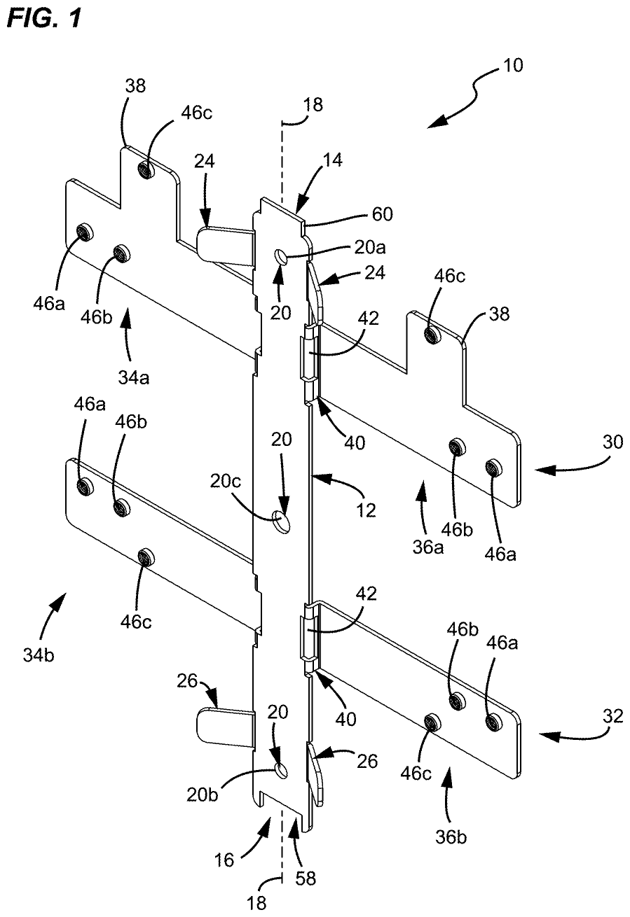

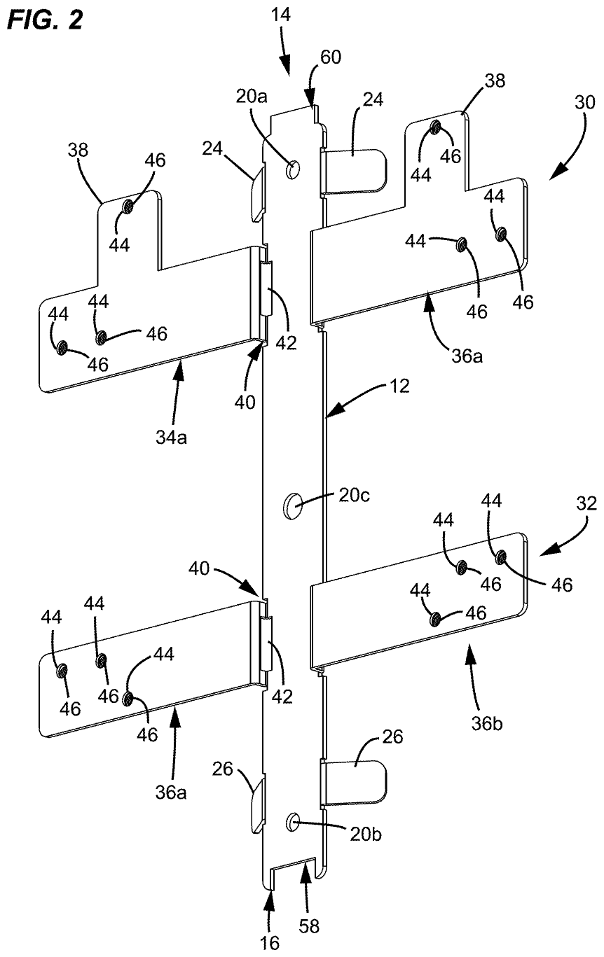

As presented at FIGS. 1-5, an example pole mounting bracket 10 for mounting at least two different types of telecommunications enclosures and optionally a skirt in an indoor or outdoor environment is shown. The pole mounting bracket 10 can be made from a variety of metallic materials. In one example, the pole mounting bracket 10 can be stamped from a single sheet of metal, such as, steel or aluminum.

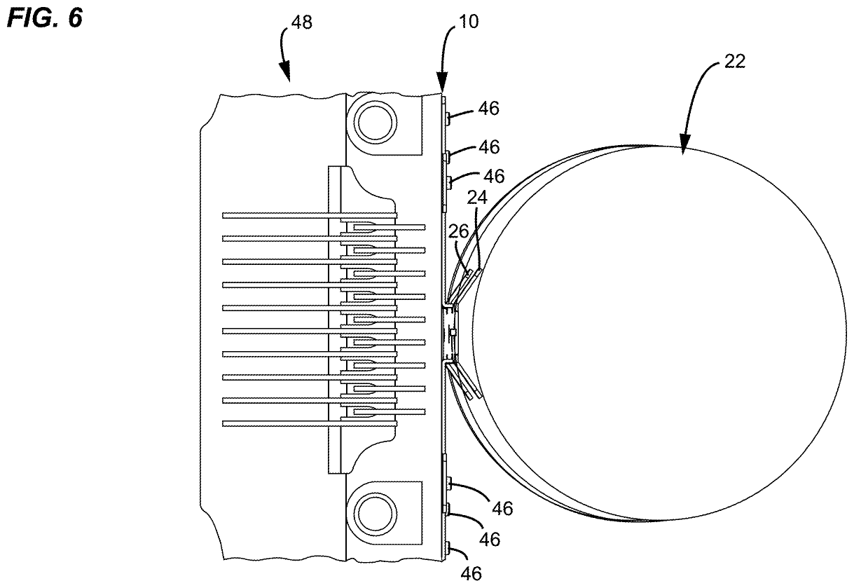

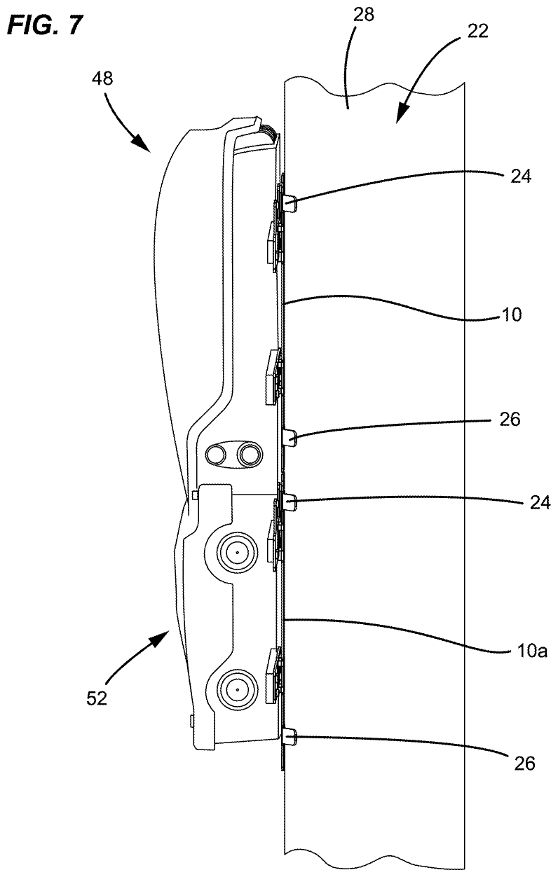

As shown, the pole mounting bracket 10 includes a central support section 12 including a first end 14 and an opposite, second end 16. The central support section 12 can be elongated along a longitudinal axis 18 between the first end 14 and the second end 16. The central support section 12 can define a plurality of fastener openings generally represented by reference number 20 along the longitudinal axis 18. In certain examples, a center opening 20c in the central support section 12 can have a diameter of about 0.6 inches and top and bottom openings 20a, 20b in the central support section 12 can have a diameter of about 0.4 inches, but the openings 20 can be other sizes as well. The plurality of fastener openings 20 can receive fasteners to connect or fix the pole mounting bracket 10 to a post 22 (e.g., pole)(see FIGS. 6-7). Example fasteners can include, but are not limited to, screws, bolts.

The central support section 12 can include a first set of tab arms 24 that extends from opposite sides of the central support section 12 adjacent the first end 14 and a second set of tab arms 26 that extend from opposite sides of the central support section 12 adjacent the second end 16. In certain examples, the first and second set of tab arms 24, 26 can be integrally formed with the central support section 12. When the pole mounting bracket 10 is mounted to the post 22, the first and second set of tab arms 24, 26 engage against an outer surface 28 of the post 22 to help align or stabilize the pole mounting bracket 10 on the post 22. In certain examples, the first and second set of tab arms 24, 26 can be bent relative to the central support section 12 to define an angle θ that is in the range of 10-45 degrees. In certain examples, the first and second set of tab arms 24, 26 can be angled in the range of 20-24 degrees relative to the central support section 12, although alternatives are possible.

In certain examples, the first and second set of tab arms 24, 26 can have a length L that extends from the central support section 12. In certain examples, the length L is about 1 to 2 inches. Preferably, the length L is about 1.5 inches. The first and second set of tab arms 24, 26 can have a width W. In certain examples, the width W is about 0.5 inches. Preferably, the width W is about 1 inch.

The pole mounting bracket 10 can also include a first lateral support member 30 transversely aligned relative to the central support section 12 and a second lateral support member 32 transversely aligned relative to the central support section 12. The second lateral support member 32 can be positioned parallel to the first lateral support member 30. The first and second lateral support members 30, 32 can be stepped forwardly from the central support section 12 to be positioned offset relative to the central support section 12. The first and second lateral support members 30, 32 each include a left portion 34a, 34b that projects laterally out from the central support section 12 and a right portion 36a, 36b that projects laterally out from the central support section 12. The left and right portions 34, 36 of the first and second lateral support members 30, 32 together expand a total length L₁. In certain examples, the length L₁ is about 10 inches to about 20 inches. In certain examples, the length L₁ is at least 12 inches. In certain examples, the length L₁ is at least 14 inches. Preferably, the length L₁ is about 16 inches. The first and second lateral support members 30, 32 can each have a length L₂. In certain examples, the length L₂ of the first and second lateral support members 30, 32 is about 5 to 8 inches. Preferably, the length L₂ of the first and second lateral support members 30, 32 is about 7 inches.

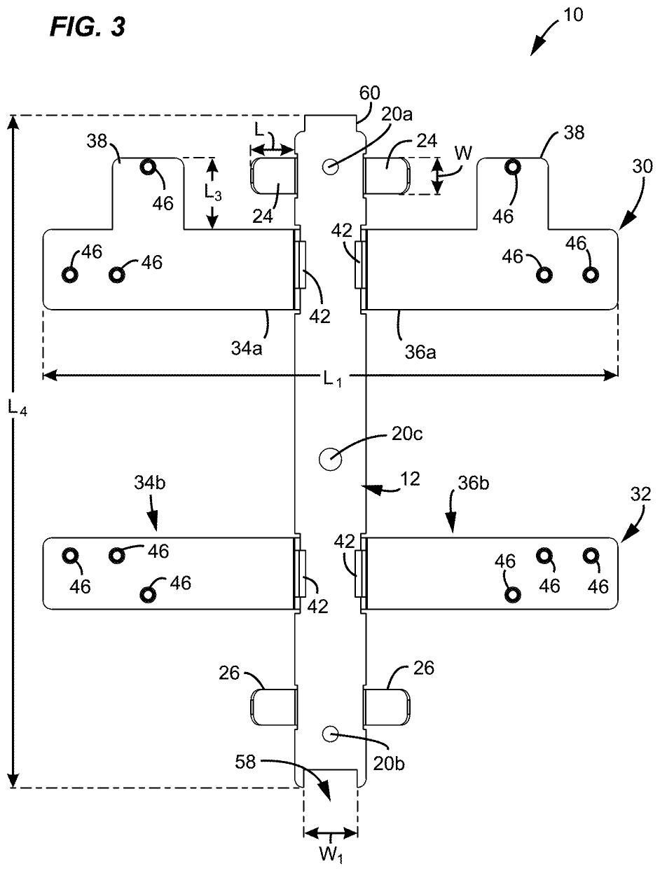

At least one of the first and second lateral support members 30, 32 can include tabs 38. In the example shown, the first lateral support member 30 include tabs 38 that extend parallel to the central support section 12. The tabs 38 can have a length L₃ (see FIG. 3) that extends from the first lateral support member 30. In certain examples, the length L₃ is about 1 to 3 inches. Preferably, the length L₃ is about 2 inches.

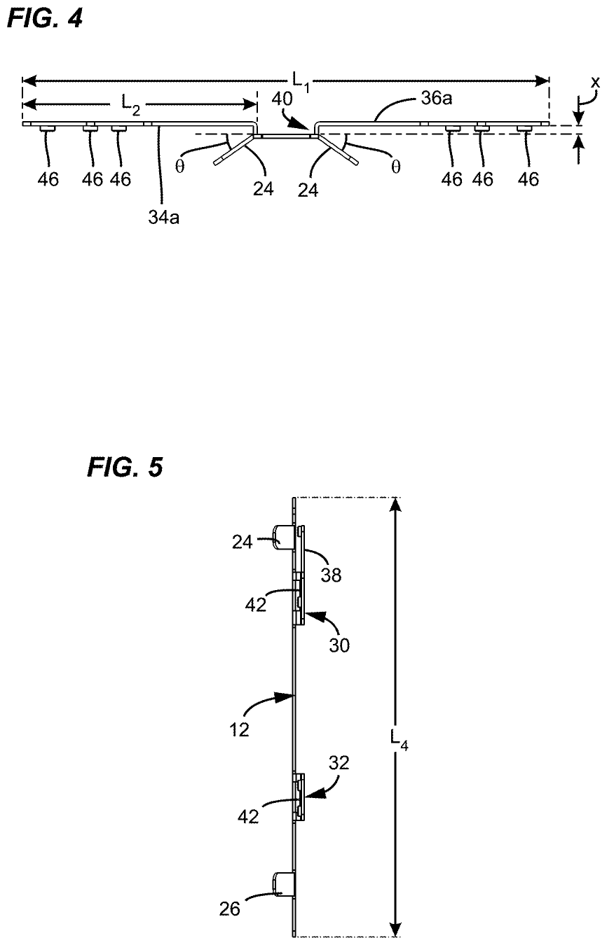

Stepped portions 40 can be provided between the central support section 12 and the first and second lateral support members 30, 32. As such, the first and second lateral support members 30, 32 can be stepped forwardly from the central support section 12 to be positioned offset relative to the central support section 12. In certain examples, the stepped portions 40 can define a slot 42 to allow the space needed to receive at least one strap (e.g., cable tie, snap hook, wire, bungee cord, springs, or rope)(not shown) for mounting around the post 22 to secure the pole mounting bracket 10 to the post 22. The stepped portions 40 can be spaced a distance X (see FIG. 4) relative to the central support section 12. In certain examples, the distance X can be up to about 5 inches. In certain examples, the distance X is between about 1 inch to about 3 inches. Preferably, the distance X is about 0.5 inches.

The first and second lateral support members 30, 32 can each define a plurality of apertures 44 that have mounting structures 46 (e.g., internally threaded fastening elements such as press-fit fastening nuts) secured therein for mounting enclosures to the first and second lateral support members 30, 32 via fasteners such as bolts. There are at least two different sets of mounting structure 46 corresponding to two different enclosures. Fasteners, such as bolts, can be threaded through the mounting structures 46 to operatively connect at least two different types of enclosures to the first and second lateral support members 30, 32. That is, the plurality of apertures 44 can be arranged and configured to provide different configurations of mounting structures 46 for mounting different enclosures.

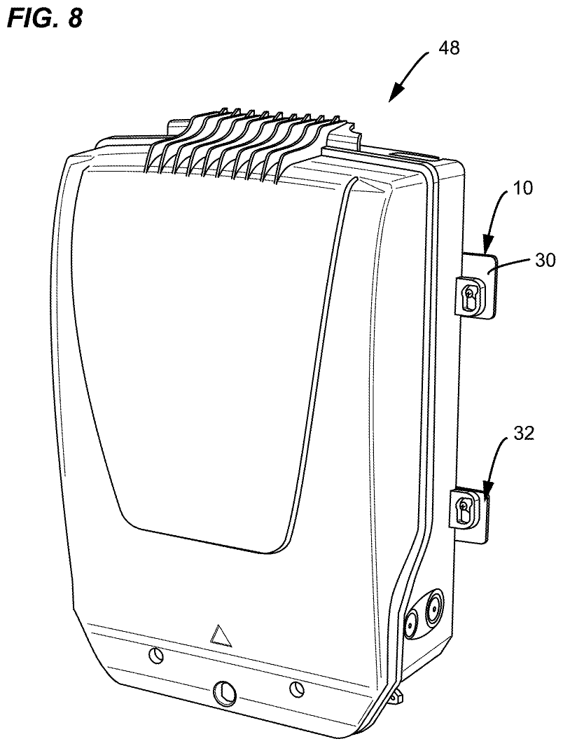

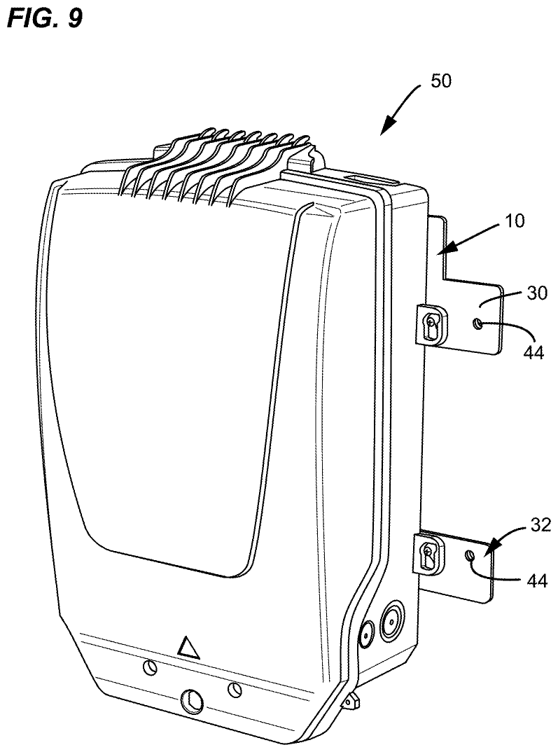

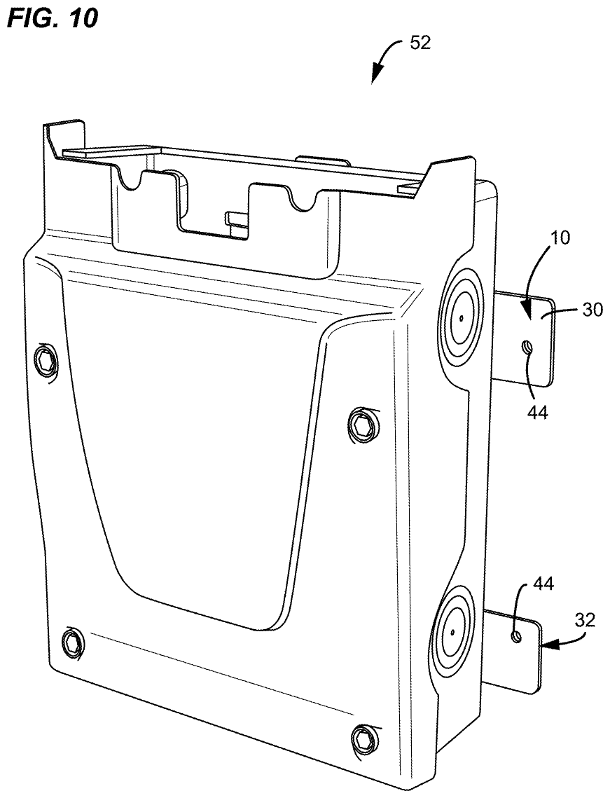

In one example, mounting structures 46a of the first and second lateral support members 30, 32 can be arranged in a first mounting configuration to support a first type of enclosure 48 (see FIG. 8). In another example, mounting structures 46b of the first and second lateral support members 30, 32 can be arranged in a second mounting configuration to support a second type of enclosure 50 (see FIG. 9). In certain examples, the first type of enclosure 48 is larger than the second type of enclosure 50.

The first and second types of enclosures can be configured as housings such as boxes that enclose telecommunications components (e.g., optical connection points such as fiber optic adapters, passive optical splitters, wavelength division multiplexers, optical splices, cables, etc.) in an outdoor or outdoor environment. The first and second types of enclosures can be utilized as a final distribution point in a “Fiber to the X (FTTX)” network, for example in a network where individual fibers from the enclosures are routed to subscriber locations.

In certain examples, the first type of enclosure 48 can be a Budi-M type enclosure sold by Commscope® and the second type of enclosure 50 can be a Budi-S type enclosure sold by Commscope®. In other examples, the mounting structures 46c of the first and second lateral support members 30, 32 can be arranged in a third mounting configuration to support an enclosure skirt 52 (see FIG. 10).

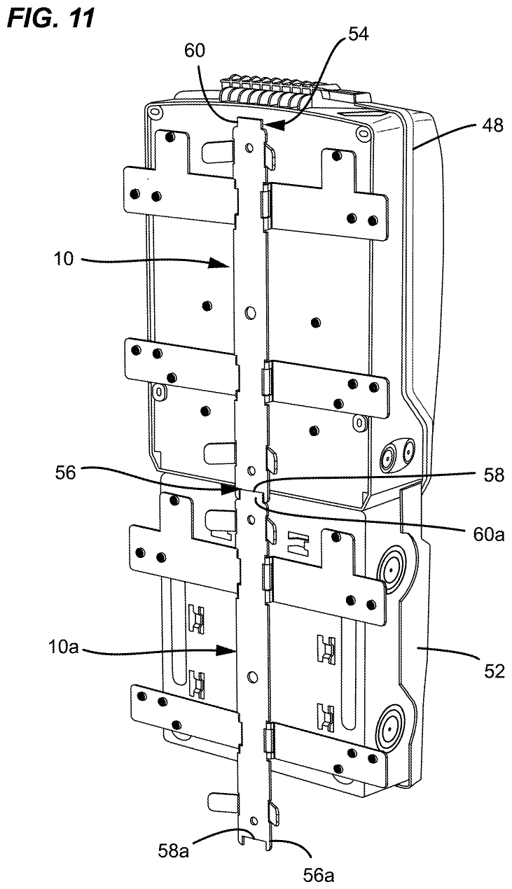

Turning to FIG. 11, the pole mounting bracket 10 can be adapted to be aligned end-to-end with respect to another pole mounting bracket 10a via a mating alignment interface. The central support section 12 of the pole mounting bracket 10 can include a trailing end 54 and an insertion end 56 that defines a notch 58. The trailing end 54 includes a projection 60 that extends in a direction parallel to the central support section 12 along the longitudinal axis 18. The notch 58 can have a width Wi (see FIG. 3). In certain examples, the width Wi is about 1 inch to 2 inches. Preferably, the width Wi is about 1.5 inches. The notches 58 and projections 60 of the pole mounting bracket 10 allow the pole mounting brackets 10, 10a to be aligned end-to-end. That is, the notch 58 at the insertion end 56 is configured to receive a projection 60a at a trailing end 54a of another pole mounting bracket 10a. As shown, the first type of enclosure 48 is mounted to the pole mounting bracket 10 and the enclosure skirt 52 is mounted to another pole mounting bracket 10a below the first type of enclosure 48.

In certain examples, the central support section 12 of the pole mounting bracket 10 can have a length L4 (see FIG. 3) defined between the insertion end 56 to the trailing end 54 of the central support section 12. In certain examples, the length L4 is about 15 inches to about 20 inches. Preferably, the length L4 is about 18 inches.

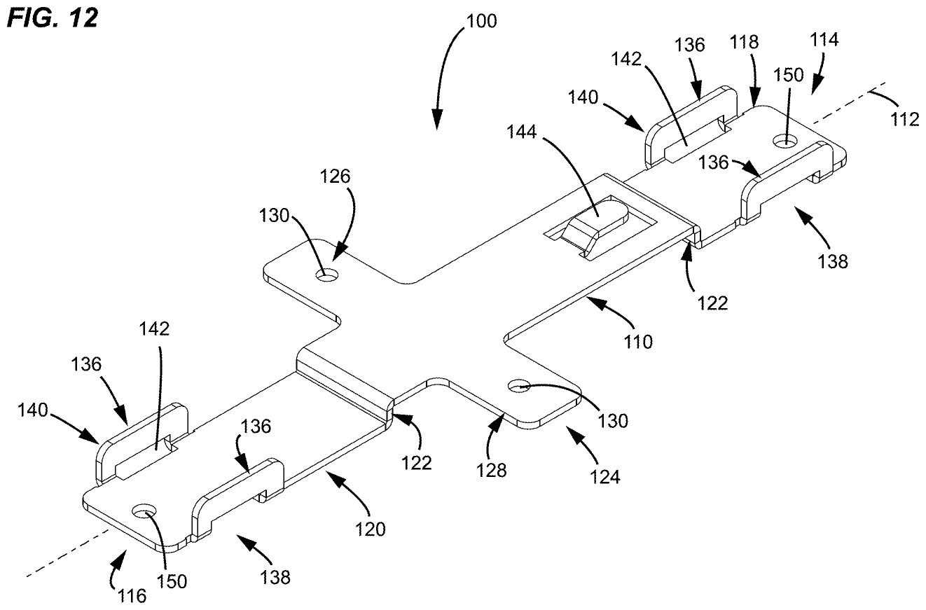

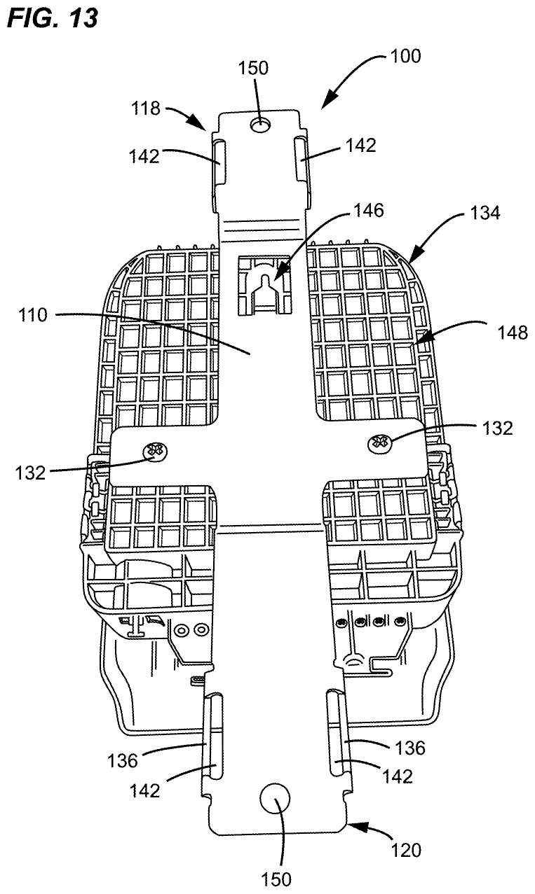

Referring now to FIGS. 12 and 13, an alternative pole mounting bracket 100 is shown. To the extent that the embodiments are similar, the description will not be repeated and will instead be directed to the primary differences. In general, the pole mounting bracket 100 differs in that it is configured for one type of enclosure.

The pole mounting bracket 100 can include a main support section 110 that has a first end 114 and an opposite, second end 116. The main support section 110 can be elongated along a longitudinal axis 112 between the first end 114 and the second end 116. The pole mounting bracket 100 includes a upper section 118 aligned parallel to the main support section 110 and a lower section 120 aligned parallel to the main support section 110 and the upper section 118. The upper and lower sections 118, 120 are stepped rearwardly from the main support section 110 by stepped portions 122 to be positioned offset relative to the main support section 110. The pole mounting bracket 100 also includes a lateral support member 124 transversely aligned relative to the main support section 110. The lateral support member 124 includes a left portion 126 that projects laterally out from the main support section 110 and a right portion 128 that projects laterally out from the main support section 110. The left and right portions 126, 128 of the lateral support member 124 can each define an aperture 130 for receiving a fastener 132 adapted to operatively connect an enclosure 134 to the lateral support member 124. In certain examples, internally threaded fasteners of the type described above can be mounted (e.g., press-fit or otherwise secured in) apertures 130.

The upper and lower sections 118, 120 can each include a pair of arms 136 on opposing sides 138, 140 thereof. Slots 142 can be defined by the pair of arms 136 and the upper and lower sections 118, 120 of the pole mounting bracket 100 at the opposing sides 138, 140 thereof. The slots 142 can be configured to receive at least one strap (not shown) for securing the pole mounting bracket 100 to a post. The main support section 100 can also include a tab 144 that is adapted to fit within an opening 146 defined at a rear side 148 of the enclosure 134 when the enclosure 134 is attached to the pole mounting bracket 100. The upper and lower sections 118, 120 each define an aperture 150 for receiving a fastener, such as a screw, to mount the pole mounting bracket 100 to a post.

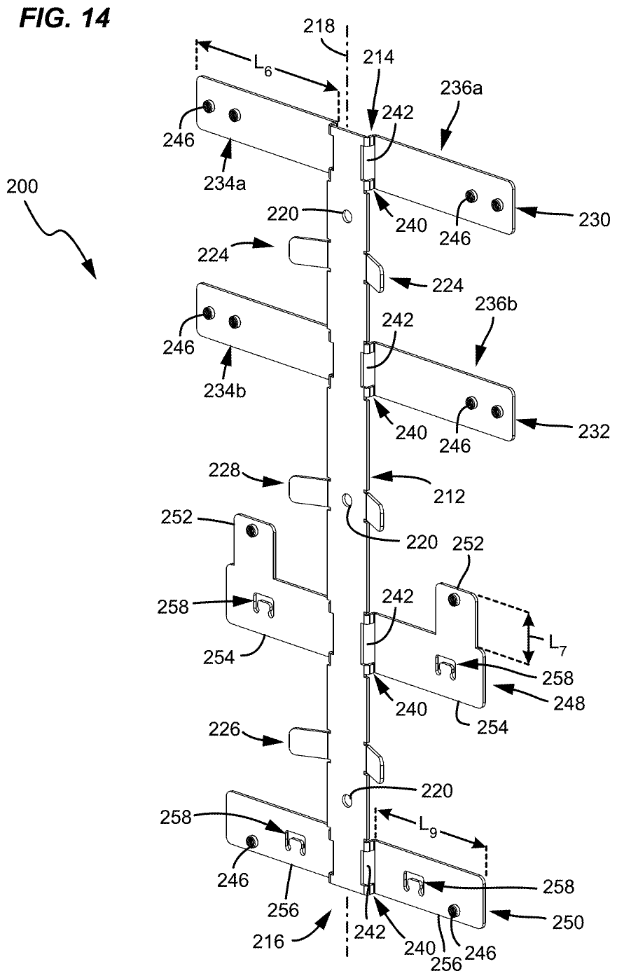

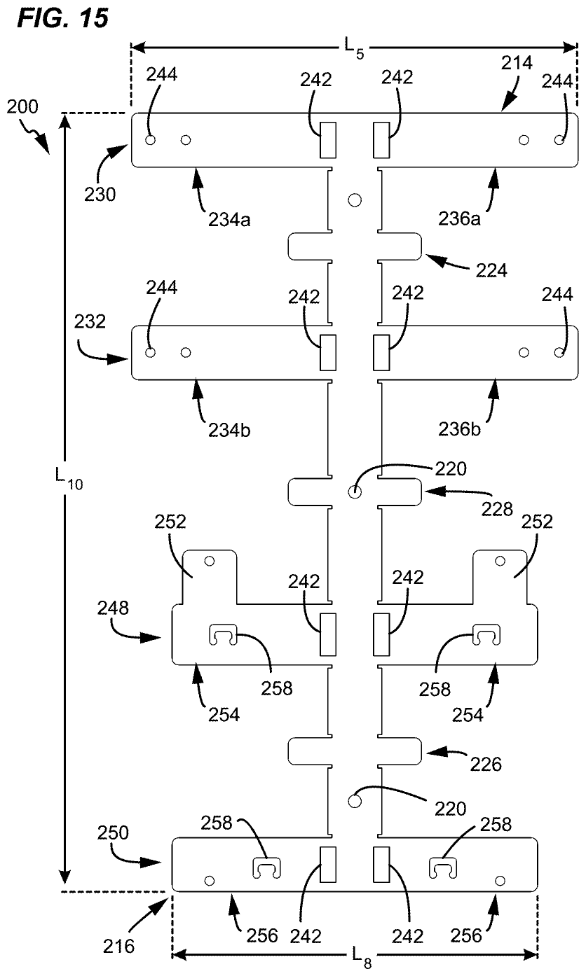

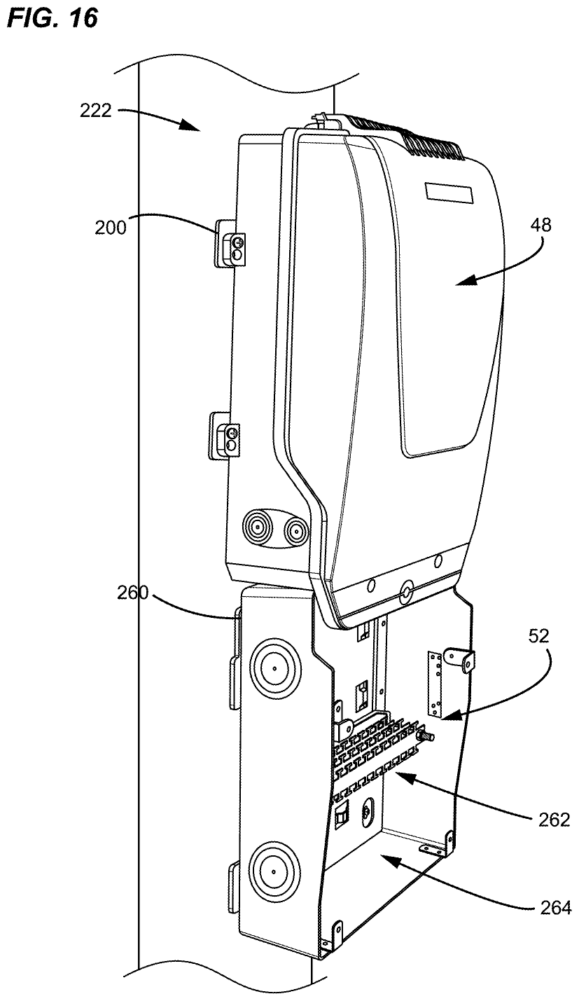

Referring now to FIGS. 14 and 15, an alternative pole mounting bracket 200 is shown. To the extent that the embodiments are similar, the description will not be repeated and will instead be directed to the primary differences. In general, the pole mounting bracket 200 differs in that it is a single bracket used for mounting the first and second type of enclosures 48, 50 and the enclosure skirt 52.

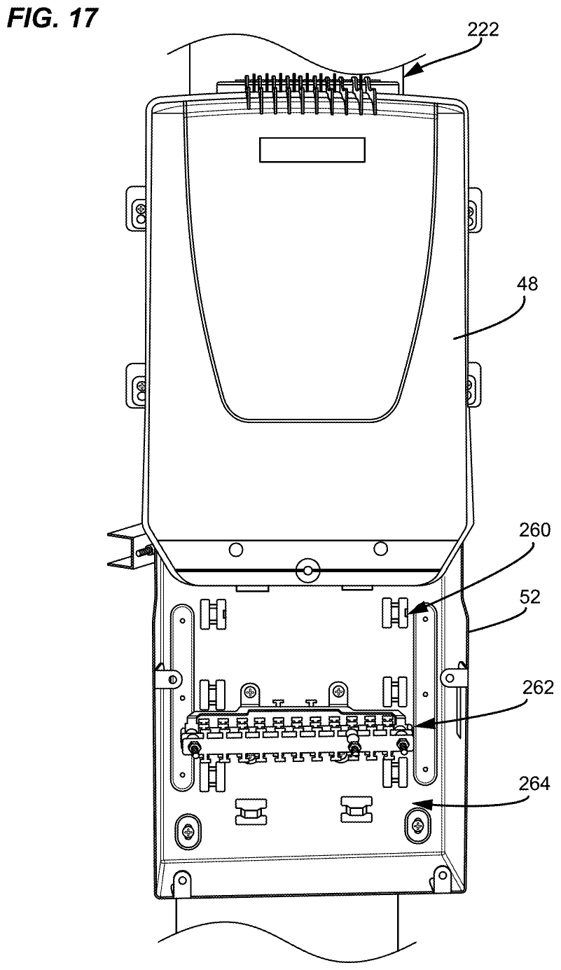

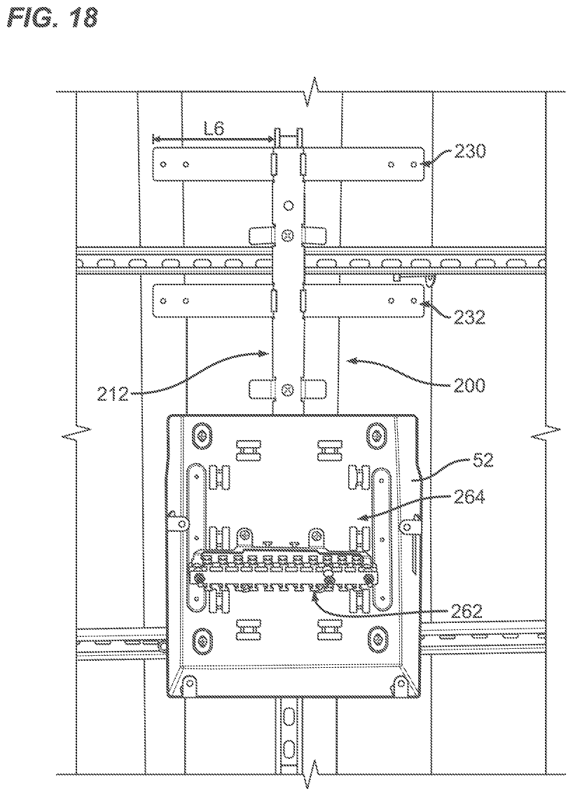

As shown, the pole mounting bracket 200 includes a central support section 212 including a first end 214 and an opposite, second end 216. The central support section 212 can be elongated along a longitudinal axis 218 between the first end 214 and the second end 216. The central support section 212 can define a plurality of fastener openings generally represented by reference number 220 along the longitudinal axis 218. In certain examples, the diameter of the fastener openings are between about 0.4 inches and about 0.6 inches, but the openings 220 can be other sizes as well. The plurality of fastener openings 220 can receive fasteners to connect or fix the pole mounting bracket 200 to a post 222 (e.g., pole)(see FIGS. 16-18). Example fasteners can include, but are not limited to, screws, bolts.

The central support section 212 can include a first set of tab arms 224 that extends from opposite sides of the central support section 212 adjacent the first end 214, a second set of tab arms 226 that extend from opposite sides of the central support section 122 adjacent the second end 216, and a third set of tab arms 228 that extend from opposite sides of the central support section at a central location between the first and seconds ends 214, 216. The first, second, third set of tab arms 224, 226, 228 having similar features to the first and second set of tab arms 24, 26 described above.

In certain examples, the first, second, third set of tab arms 224, 226, 228 can be integrally formed with the central support section 212. When the pole mounting bracket 200 is mounted to the post 222, the first, second, third set of tab arms 224, 226, 228 engage against the post 222 to help align or stabilize the pole mounting bracket 200 on the post 222.

The pole mounting bracket 200 can also include a first lateral support member 230 transversely aligned relative to the central support section 212 and a second lateral support member 232 transversely aligned relative to the central support section 212. The second lateral support member 232 can be positioned parallel to the first lateral support member 230. The first and second lateral support members 230, 232 can be stepped forwardly from the central support section 212 to be positioned offset relative to the central support section 212. The first and second lateral support members 230, 232 each include a left portion 234a, 234b that projects laterally out from the central support section 212 and a right portion 236a, 236b that projects laterally out from the central support section 212. The left and right portions 234, 236 of the first and second lateral support members 230, 232 together expand a total length L₅. In certain examples, the length L₅ is about 10 inches to about 20 inches. In certain examples, the length L₅ is at least 12 inches. In certain examples, the length L₅ is at least 14 inches. Preferably, the length L₅ is about 16 inches. The left and right portions 234, 236 of the first and second lateral support members 230, 232 can each have a length L₆. In certain examples, the length L₆ of the left and right portions 234, 236 of the first and second lateral support members 30, 32 is about 5 to 8 inches. Preferably, the length L₆ of the left and right portions 234, 236 of the first and second lateral support members 30, 32 is about 7 inches.

Stepped portions 240 can be provided between the central support section 212 and the first and second lateral support members 230, 232. As such, the first and second lateral support members 230, 232 can be stepped forwardly from the central support section 212 to be positioned offset relative to the central support section 212 as described above with reference to the first and second lateral support members 30, 32. In certain examples, the stepped portions 240 can define a slot 242 to allow the space needed to receive at least one strap (e.g., cable tie, snap hook, wire, bungee cord, springs, or rope)(not shown) for mounting around the post 222 to secure the pole mounting bracket 200 to the post 222.

The first and second lateral support members 230, 232 can each define a plurality of apertures 244 that have mounting structures 246 (e.g., internally threaded fastening elements such as press-fit fastening nuts) secured therein for mounting enclosures to the first and second lateral support members 230, 232 via fasteners such as bolts. Fasteners, such as bolts, can be threaded through the mounting structures 246 to operatively connect the first and second type of enclosures 48, 50 to the first and second lateral support members 230, 232.

The pole mounting bracket 200 includes third and fourth lateral supports 248, 250. The third lateral support 248 includes tabs 252 that extend parallel to the central support section 212. The tabs 252 can have a length L₇ that extend from left and right lateral support members 254 of the third lateral support 248. In certain examples, the length L₇ is about 1 to 3 inches. Preferably, the length L₇ is about 2 inches.

The fourth lateral support 250 also includes left and right lateral support members 256. The left and right lateral support members 254, 256 each include tie points 258 to organize/store drop cables when the enclosure skirt 52 is not used. The third and fourth lateral supports 248, 250 of the pole mounting bracket 200 are configured to support the enclosure skirt 52.

The left and right portions 254, 256 of the third and fourth lateral support members 248, 250 together expand a total length L₈. In certain examples, the length L₈ is about 10 inches to about 20 inches. In certain examples, the length L₈ is at least 14 inches. Preferably, the length L₈ is about 13 inches. The left and right portions 254, 256 of the third and fourth lateral support members 248, 250 can each have a length L₉. In certain examples, the length L₉ of the left and right portions 254, 256 is about 2 to 5 inches. Preferably, the length L₆ of the left and right portions 254, 256 of the first and second lateral support members 248, 250 is about 4 inches.

In certain examples, the central support section 212 of the pole mounting bracket 200 can have a length L₁₀ defined between the first and second ends 214, 216 of the central support section 212. In certain examples, the length L₁₀ is about 25 inches to about 30 inches. Preferably, the length L₁₀ is about 28 inches.

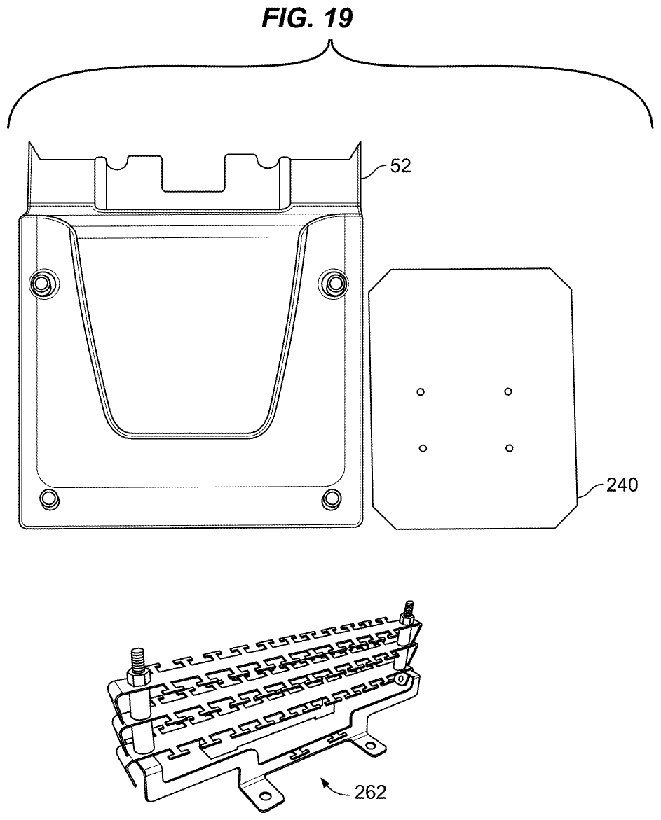

FIGS. 16-18 show both the first type of enclosure 48 and the enclosure skirt 52 mounted to the pole mounting bracket 400. The pole mounting bracket 400 may be mounted to metal, aluminum, or wooden poles. In other examples, the pole mounting bracket 400 may be mounted to a Unistruct frame. In certain examples, a skirt back plate 260 (see FIG. 19) may be mounted to the enclosure skirt 52 which can then be mounted to the pole 222. The skirt back plate 260 is designed to help keep pests and flying insects out of the enclosure skirt 52. The enclosure skirt 52 can also include an organizer 262 positioned within an interior 264 of the enclosure skirt 52.

From the forgoing detailed description, it will be evident that modifications and variations can be made without departing from the spirit and scope of the disclosure.

What is claimed is:

1. A pole mounting bracket comprising:
a central support section including a first end and an opposite, second end, the central support section being elongated along a longitudinal axis between the first end and the second end, the central support section defining a plurality of fastener openings along the longitudinal axis;
a first lateral support member transversely aligned relative to the central support section; and
a second lateral support member transversely aligned relative to the central support section, the second lateral support member being parallel to the first lateral support member;
wherein the first and second lateral support members are stepped forwardly from the central support section to be positioned offset relative to the central support section; and
wherein the first and second lateral support members each define a plurality of apertures for receiving mounting structures adapted to operatively connect at least two different types of enclosures to the first and second lateral support members.

2. The pole mounting bracket of claim 1, wherein the mounting structures of the first and second lateral support members are arranged in a first mounting configuration to support a first type of enclosure.

3. The pole mounting bracket of claim 2, wherein the mounting structures of the first and second lateral support members are arranged in a second mounting configuration to support a second type of enclosure.

4. The pole mounting bracket of claim 3, wherein the first type of enclosure is larger than the second type of enclosure.

5. The pole mounting bracket of claim 3, wherein the mounting structures of the first and second lateral support members are arranged in a third mounting configuration to support an enclosure skirt.

6. The pole mounting bracket of claim 1, wherein the first lateral support member includes tabs that extend parallel to the central support section.

7. The pole mounting bracket of claim 1, wherein the first and second lateral support members each include a left portion that projects laterally out from the central support section and a right portion that projects laterally out from the central support section.

8. The pole mounting bracket of claim 1, wherein the central support section includes a first set of tab arms that extend from opposite sides of the central support section adjacent the first end.

9. The pole mounting bracket of claim 8, wherein the central support section includes a second set of tab arms that extend from opposite sides of the central support section adjacent the second end.

10. The pole mounting bracket of claim 9, wherein the first and second sets of tab arms are integrally formed with the central support section.

11. The pole mounting bracket of claim 9, wherein the pole mounting bracket is adapted to be aligned end-to-end with respect to another pole mounting bracket via a mating alignment interface.

12. The pole mounting bracket of claim 11, wherein the central support section of the pole mounting bracket includes a trailing end and an insertion end, wherein the trailing end includes a projection that extends in a direction parallel to the central support section along the longitudinal axis.

13. The pole mounting bracket of claim 12, wherein the insertion end is configured to receive the projection of the trailing end of another pole mounting bracket.

14. The pole mounting bracket of claim 1, wherein stepped portions between the central support section and the first and second lateral support members each define a slot, wherein at least one strap is provided for extending around a post and through the slots for securing the pole mounting bracket to the post.

15. A pole mounting bracket comprising:
a main support section including a first end and an opposite, second end, the main support section being elongated along a longitudinal axis between the first end and the second end;
an upper section aligned parallel to the main support section;
a lower section aligned parallel to the main support section and the upper section; and
a lateral support member transversely aligned relative to the main support section, the lateral support member including a left portion that projects laterally out from the main support section and a right portion that projects laterally out from the main support section;
wherein the upper and lower sections are stepped rearwardly from the main support section to be positioned offset relative to the main support section; and
wherein the left and right portions of the lateral support member each define an aperture for receiving a mounting structure adapted to operatively connect an enclosure to the lateral support member.

16. The pole mounting bracket of claim 15, wherein the upper and lower sections each include a pair of arms on opposing sides thereof, slots being defined at the opposing sides by the pair of arms.

17. The pole mounting bracket of claim 16, wherein the slots are configured for receiving at least one strap for securing the pole mounting bracket to a post, and wherein the main support section includes a tab for mounting to the enclosure.

18. The pole mounting bracket of claim 15, wherein the upper and lower sections each define an aperture for receiving a screw adapted to mount the pole mounting bracket to a post.

19. A pole mounting bracket comprising:
a central support section including a first end and an opposite, second end, the central support section being elongated along a longitudinal axis between the first end and the second end, the central support section defining a plurality of fastener openings along the longitudinal axis, wherein the central support section includes a first set of tab arms that extend from opposite sides of the central support section adjacent the first end and a second set of tab arms that extend from opposite sides of the central support section adjacent the second end;
a first lateral support member transversely aligned relative to the central support section; and
a second lateral support member transversely aligned relative to the central support section, the second lateral support member being parallel to the first lateral support member;
wherein the first and second lateral support members are stepped forwardly from the central support section to be positioned offset relative to the central support section, wherein stepped portions between the central support section and the first and second lateral support members each define a slot; and
wherein the first and second lateral support members are adapted to operatively connect at least two different types of enclosures to the first and second lateral support members.

20. A pole mounting bracket comprising:
a central support section including a first end and an opposite, second end, the central support section being elongated along a longitudinal axis between the first end and the second end, the central support section defining a plurality of fastener openings along the longitudinal axis;
a first lateral support member transversely aligned relative to the central support section;
a second lateral support member transversely aligned relative to the central support section;
a third lateral support member transversely aligned relative to the central support section; and
a fourth lateral support member transversely aligned relative to the central support section; the first, second, third, and fourth lateral support members being parallel to one another;
wherein the first, second, third, and fourth lateral support members are stepped forwardly from the central support section to be positioned offset relative to the central support section;
wherein the first and second lateral support members each define a plurality of apertures for receiving mounting structures adapted to operatively connect at least two different types of enclosures to the first and second lateral support members; and
wherein the third and fourth lateral support members each define a plurality of apertures for receiving mounting structures adapted to operatively connect an enclosure skirt to the third and fourth lateral support members.
